(19) United States
(12) Patent Application Publication
(10) Pub. No.: US 2003/0083951 A1
(43) Pub. Date: May 1, 2003

(54) System and method for providing an ordered listing of available, currently broadcasting, and/or acquired products based on predicted relevance

(76) Inventor: Jay H. Connelly, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/002,129

(22) Filed: Oct. 31, 2001

(51) Int. Cl. G06F 17/60

(52) U.S. Cl. 705/26

(57) ABSTRACT

A system and method for providing an ordered listing of currently playing, available and/or acquired products based on predicted relevance. A method comprises receiving a delivery schedule from a server listing a plurality of available products available from the server, creating an ordered list of available products by evaluating the available products based on consumer preferences, and presenting the ordered list of available products to the consumer. Another method similarly includes creating an ordered list of available products by evaluating stored products based on consumer preferences, and presenting the ordered list of stored products to the consumer. Yet another method includes creating an ordered list of currently playing products based on consumer preferences, and presenting the ordered list to the consumer. The method may be implemented on a set-top box or other personal computing device coupled to a television display and a delivery center server.

### FIELD OF THE INVENTION

The invention relates generally to a set-top box or other personal computing device, including a personal computer, coupled to a broadcast system and, more specifically, to listing products that are available to be acquired by a consumer via the consumer's set-top box, to listing products that are currently being broadcast that may be viewed or otherwise accessed by a consumer via a set-top box, and/or to listing products that have been acquired for a consumer via the consumer's set-top box.

### BACKGROUND OF THE INVENTION

Broadcast systems traditionally transmit data in one direction from a server system to a plurality of client systems. Consumers of the client systems typically receive the signals from the server system as they are broadcast. One paradigm in which consumers are provided with explicitly selected content involves server systems that broadcast the same data continuously and/or at staggered intervals, such as, for example “pay per view” movies. “Pay per view” movies are available from cable or satellite television broadcasters that send the same movies repeatedly on multiple channels at staggered intervals. Consumers that wish to watch a particular movie simply tune in to one of the channels on which the desired movie is broadcast at a particular known broadcast time.

Another paradigm for providing explicitly selected content in a broadcast system involves a consumer recording a particular program, movie, sporting event, or other content, and later accessing it at a time after it was broadcast. Traditionally, a consumer sets a video cassette recorder (VCR) to record a desired television program. Later, when the consumer wishes to watch the television program, the consumer simply plays the earlier recorded program from the VCR.

More recently, digital video recorders (also known as personal video recorders) having functionality provided by TiVo, Inc. of Alviso, Calif. and Replay TV/SONICblue Incorporated of Santa Clara, Calif. paired with digital broadcast services have become available. These paired device and service offerings allow for content broadcasts to be recorded on internal hard disk drives rather than the video cassette tapes used by traditional VCRs. Consumers may use digital video recorders in a manner similar to traditional VCRs in that consumers explicitly set the criteria used to determine which broadcasts are recorded on the internal hard drives by specifying a date and time of a desired program or other content. Current systems provide a consumer a list of currently broadcast programs in channel order arranged by time and date. Similarly, current systems provide a user a list of programs which will be available for acquisition in date and time order according to channel. These broadcasts may be selected by a consumer traversing a program guide listing of all shows available on all channels arranged in date and time order by channel. As such, it is not particularly easy, and it may be somewhat difficult for a consumer to traverse such a program guide listing to find a desired program. In addition, these broadcast systems allow consumers to explicitly provide general preferences regarding likes, preferences, favorites, etc. For example, TiVo® systems allow a consumer to explicitly give a “thumbs up” or “thumbs down” for a program or movie and to explicitly provide a “wish list” of movie or program criteria. TiVo® systems then acquire movies and programs matching the explicitly selected criteria to the consumer. Current systems such as those available from TiVo® and Reply TV are limited to providing a list of acquired programs in time order based on the day and time when the program was acquired.

None of the currently available systems allow a consumer to view a list of available programs in predicted relevance order. None of the currently available systems allow a consumer to view a list of currently broadcast programs in predicted relevance order. And none of the currently available systems allow a consumer to view a list of acquired and stored programs in predicted relevance order.

### BRIEF DESCRIPTION OF THE DRAWINGS

FIG. 1 illustrates an environment in which one embodiment of the invention executes.

FIG. 2A illustrates product description data according to an embodiment of the invention.

FIG. 2B illustrates a delivery schedule according to an embodiment of the invention.

FIG. 2C illustrates a group of packages of products according to one embodiment of the invention.

FIG. 3A illustrates a general flow of actions taken pursuant to one embodiment of the invention.

FIG. 3B illustrates a flow of actions taken pursuant to one embodiment of the invention.

FIG. 4 illustrates a flow actions taken to prepare a set of predictive vectors for a consumer pursuant to one embodiment of the invention.

FIG. 5 illustrates a set of predictive vectors according to one embodiment of the invention.

FIG. 6 illustrates a flow of actions taken to prepare an ordered listing of stored products according to one embodiment of the invention.

### DETAILED DESCRIPTION

A. An Environment of a Delivery Center and Clients

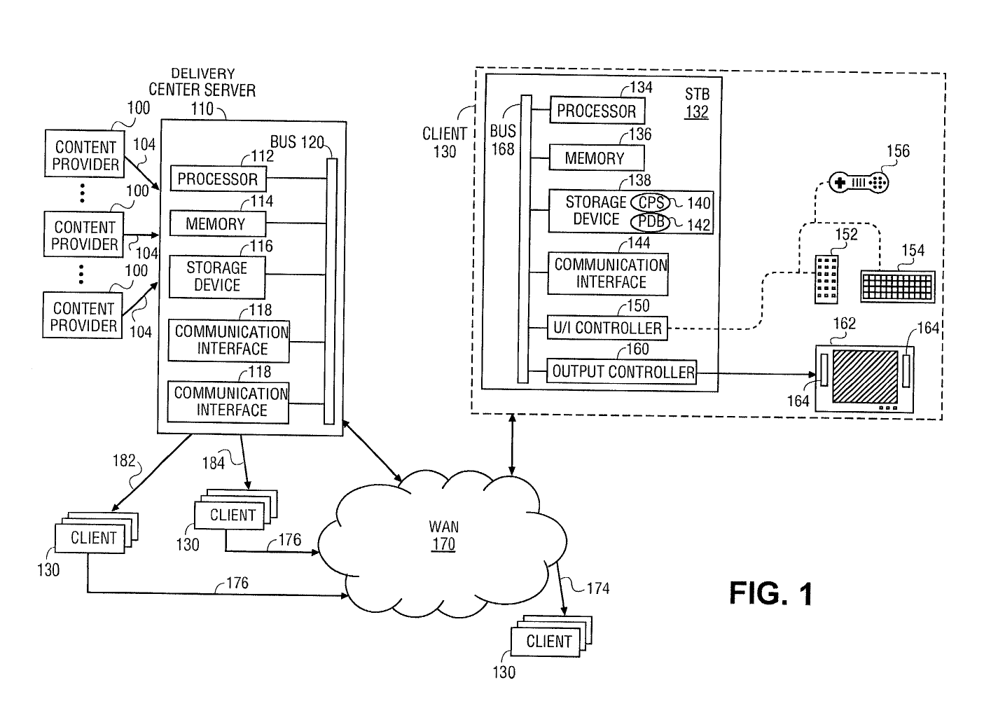

FIG. 1 illustrates an environment in which one embodiment of the invention executes. The invention involves at least one content provider 100 that provides products to a broadcast delivery center server 110. The content provider may provide products in an analog or a digital format. In one embodiment, if a product is recorded in an analog format, it may be converted into a digital format by delivery center server 110. Each content provider 100 may be a server computer or a group, subnetwork, local area network (LAN) or other group of multiple computers. The products may be television programs, movies, shorts, raw data, voice, audio, video, music videos, video games, computer programs, graphics, or some combination of these or other similar data. In one embodiment, the format of the products sent to the clients from the delivery center server may be any digital data format including, for example, data interchange formats such as Internet Protocol (IP) Packets and File Transfer Protocol (FTP) packets; combined audio and moving video formats such as the Digital Video Interface (DVI) format, Indeo® format; formats promulgated by the International Telecommunications Union (ITU), the Advanced Television Systems Committee (ATSC), and similar organizations; Moving Pictures Expert Group (MPEG) format; related audio formats such as MPEG audio layer 3, more popularly known as MP3; still video formats such as Joint Photographic Experts Group (JPEG) format, Graphic Interchange Format (GIF), etc.; and other digital formats of data, executable software programs, audio, video, still photographs and any combination of data, executable software programs, audio, video, and still photographs. In one embodiment, the content providers provide products via connections 104. In one embodiment, connections 104 may be a land line such as T1 lines, T3 lines, coaxial cable, Ethernet, twisted-pair, fiber optic such as a Synchronous Optical Network (SONET), or other physically present connection. In another embodiment, the connection may be wireless in the form of microwave, satellite, radio wave, and the like. Delivery center server 110 may be a server computer or a group of computers including, for example, a subnetwork, cluster or a LAN. Delivery center server 110 distributes the products to consumers such as clients 130. In one embodiment, the products sent to the clients are sent in a digital format.

In one embodiment, delivery center server 110 is comprised of one or more server computers that include a processor 112, a memory 114 such as any Random Access Memory (RAM) device, at least one storage device 116 to store data such as products received from the content providers and consumer preference data received from the clients, and at least one communications interface 118. In one embodiment, multiple communications interfaces 118 are required for communication with content providers, as already described, and for communication with clients as will be described below. Storage device 116 may be any machine readable medium including hard disk drives, optical disk drives, magnetic tape, etc. In one embodiment, software implementing the method described herein may be stored on the storage device or other machine readable medium included in the delivery center server, including magnetic and optical disks; magnetic tape; read-only memory (ROM), programmable read-only memory (PROM), electronically erasable programmable memory (EEPROM), and similar semiconductor devices; or may be downloaded from any external or remote device via electrical, acoustical, or other form of propagated signal (e.g., carrier waves, digital signals, infrared signals, etc.).

In delivery center server 110, processor 112, memory 114, storage device 116, and communications interfaces 118 may be coupled to one another via bus 120. In various embodiments, delivery center server may include multiple or additional communications interfaces, processors, storage devices, and buses. Although not shown, user input devices such as a mouse and a keyboard, and a display such as a cathode ray tube (CRT) display monitor, or any display device suitable for displaying data, graphics and images, may be coupled to or included as part of the delivery center server. In one embodiment in which the delivery center server is comprised of multiple server computers, there may be dedicated communications servers, applications servers, storage servers, database servers, and other specialized servers configured as a LAN, group, subgroup, cluster, subnetwork, and the like.

In one embodiment, communications interfaces 118 of the delivery center server may provide for communications with clients 130 via a wide area network (WAN) 150, which may be the Internet or a network that supports the Transmission Control Protocol/Internet Protocol (TCP/IP) and/or other well known communications protocols; via High Definition Television (HDTV); via cable television (CATV); via satellite; via an ATSC broadcast signal; via Digital Television (DTV) signal and others by communication with appropriate transmission or communications devices such as broadcast, satellite and cable head-ends and the like, as well as via computer communications servers, routers, switches, gateways, etc. Delivery center server 10 may communicate with clients 130 by WAN or CATV over WAN connection 174, and by satellite, DTV, ATSC, and HDTV over DTV connection 182 and satellite connection 184. In various embodiments, the delivery center server and the clients may include components that allow for communication via at least one and often times multiple connections such as, for example, connections 174, 182 and 184.

The clients 130 that receive products may be a set-top box 132 coupled to a television 162. In one embodiment, set-top box 132 includes processor 134, memory 136, storage device 138, communications interface 144, user interface controller 150, and output controller 160 all coupled for communication via bus 168. In one embodiment, keyboard 154 and/or remote control key pad 152 and/or game controller 156 may be coupled with and send consumer input to set-top box 132 via user interface controller 150. In one embodiment, user interface controller 150 may be a serial bus controller, such as, for example, a Universal Serial Bus (USB) host controller. In one embodiment, television 162 may include speakers 164 for the reproduction of audio associated with delivered products. In one embodiment, communications interface 144 may be a modem which allows for communication over WAN 150 as shown by connection 174. In other embodiments, communications interface 144 may be a device which connects to a cable television receiver, a satellite receiver or other device to receive analog or digital signals from delivery center server 110 via connections 1-82 and 184.

In one embodiment, set-top box 132 may be any personal computing device such as a personal computer, portable computer, cellular telephone, personal digital assistant (PDA), computing tablet, or any other device containing a processor with a communications interface that allows for the receipt of data distributed via connections 174, 182 and 184. In one embodiment, storage device 138 may be used for storing received products, product description data, consumer preference data, etc. Such storage devices include magnetic media such as hard disk drives as well as other machine readable media internally, externally, locally or remotely coupled to the settop box. In one embodiment, the methods described herein may be implemented as software and stored as consumer preference software (CPS) 140 on storage device 138. Consumer preference data may, in one embodiment, be stored on storage device 130 in preference database (PDB) 142.

In one embodiment, some of a plurality of clients 130 may receive broadcast products wirelessly via DTV connection 182; some of a plurality of clients 130 may receive broadcast products via satellite connection 184; and, some of a plurality of clients 130 may receive broadcast products via WAN connection 174. In this embodiment, the WAN may be the Internet. In another embodiment, some of a plurality of clients may receive products via CATV connection, not shown. In one embodiment, a CATV connection may be a WAN. Other connections using other wellknown technologies are also possible.

In one embodiment, clients 130 may also send information to delivery center server 110. For clients that receive products via satellite, radio wave or other wireless connection, communication to the delivery center may be achieved via telephone dial-up connection 176 through WAN 150, such as, for example, by connecting to an Internet Service Provider (ISP) to access the Internet. In other embodiments, these clients may dial-up directly to the delivery center server. Clients who receive broadcast products wirelessly may also send communications via digital subscriber line (DSL), T1 line or other land line connection to the Internet to the delivery center. For clients that receive products via a WAN, such as via the Internet or CATV, communication to the delivery center server may be made via the WAN through which broadcast products are received, such that the flow of information is bi-directional, as shown via WAN connection 174.

In one embodiment, a delivery schedule including product description information or product description data known as meta-data is sent to the client before a particular product is to be broadcast by the broadcast center server. In one embodiment, the delivery schedule and included meta-data may be referred to as a program guide having program guide data. In this embodiment, the program guide and data may be delivered in various formats, including, but not limited to, the formats specified by the Program and System Information Protocol for Terrestrial Broadcast and Cable (PSIP) standard, revision A, of the ATSC, and the Specification for Service Information in DVB Systems (SI) standard, version 1.4.1, of the European Telecommunications Standards Institute (ETSI) of the European Broadcasting Union (EBU). In one embodiment, unknown to the consumer, the client, in the form of a smart set-top box or other personal computing device, includes CPS which, in response to receiving product description data, evaluates which broadcast products should be acquired. To determine what products should be acquired, the CPS may evaluate consumer preferences implicitly based on prior consumed product history, such as prior viewed movies and television shows, played games, viewed previews, activated computer programs, viewed data, etc., and/or based on explicitly provided consumer preferences. For example, if the consumer has viewed or specified action movies or movies starring Arnold Schwarzenegger using this implicitly obtained consumer preference data, when an action movie, a movie starring Arnold Schwarzenegger, or a movie featuring the same, and, in another embodiment, a similar star is described in meta-data sent to the consumer's set-top box, the CPS in the set-top box may transparently decide to and then acquire the movie described by the meta-data when it is broadcast by the delivery center server. That is, clients 130 are connected to the delivery center server and run a client software program such as CPS 140 on set-top box 132 that maintains consumer preferences based implicitly and transparently on the history of all products which the client has consumed, viewed, executed, sought information for, or otherwise accessed and/or based on explicitly provided consumer specified preferences. In addition, in one embodiment, the CPS may evaluate implicit consumer preferences based on those products the consumer has either ignored, not viewed, not played, not executed, not otherwise accessed when the product has been available for acquisition and/or after CPS automatic acquisition. Similarly, an implicit consumer preference may also be determined based on a consumer deleting an automatically acquired product without viewing, executing, playing or otherwise accessing the product. Accordingly, whenever the delivery center server sends information to clients informing them that certain products will be available for acquisition, such as, for example via a broadcast or delivery schedule, the CPS in the consumer's set-top box or other computing device automatically and transparently decides that certain products should be acquired when broadcast and that others should be ignored. In this way, a consumer's product preferences, based on the CPS determination of products which match the consumer's preferences, may be anticipated so that products may be transparently automatically acquired when broadcast by the delivery center server, that is, without the consumer performing any action or observing any set-top box activity.

Initially, in various embodiments no products tailored to the consumer are automatically acquired by the set-top box until consumer preferences may be determined from the consumer having a consuming history created by selecting and requesting that a product be acquired, by viewing products or otherwise accessing, executing or playing products, and/or by explicitly entering consumer preferences. In one embodiment, the client system may present menus of choices to the consumer to obtain explicit consumer preferences to prime the automatic acquisition system. For example, these menus may, depending on the product, include check-off boxes for well-known genres, subgenres, styles, geographic location of the content, stars, characters, directors, musical performers, operating system, game system, etc. Any and all kinds of criteria, features, characteristics, etc. of any product may be provided in menus to the consumer. In one embodiment, the consumer may specify key words and/or key/value pairs describing products which the consumer wishes to be transparently automatically acquire. In another embodiment, the CPS may initially acquire products based on the geographic location of the client obtained as geographic data received from the client and/or based on consumer profile information obtained when the consumer registers the set-top box, including, for example, age, gender, personal interests, income, job, etc.

In one embodiment, the CPS may access and maintain a preference database of consumer preferences in the consumer's set-top box. In one embodiment, PDB 142 may be such a database. In this embodiment, PDB 142 may be accessible via the structured query language (SQL) or other well-known database languages. In one embodiment, PDB 142 may be accessed by the CPS via JAVA Database Connectivity (JDBC) and/or Open Database Connectivity (ODBC) application programming interfaces. In other embodiments, other well known or proprietary databases and/or application programming interfaces may be used. In yet other embodiments simple lists may be maintained and used.

In one embodiment, the invention described herein involves a system such as that described regarding FIG. 1 in which product description data in the form of meta-data is forwarded by the delivery center server to clients in the form of a broadcast or delivery schedule, and client-side software, the CPS on a consumer's set-top box, automatically and transparently, without any consumer input, determines whether specified products should be acquired by the consumer's set-top box when broadcast by the delivery center server. In one embodiment, the CPS decides whether one or more products should be acquired based on consumer preference information maintained and organized by the CPS on the client's set-top box. The CPS also may display a list of available products in predicted relevance order based on the consumer preferences, may display a list of currently broadcast products in predicted relevance order based on the consumer preferences, and/or display all acquired and stored products in predicted relevance order.

B. Various Data Formats

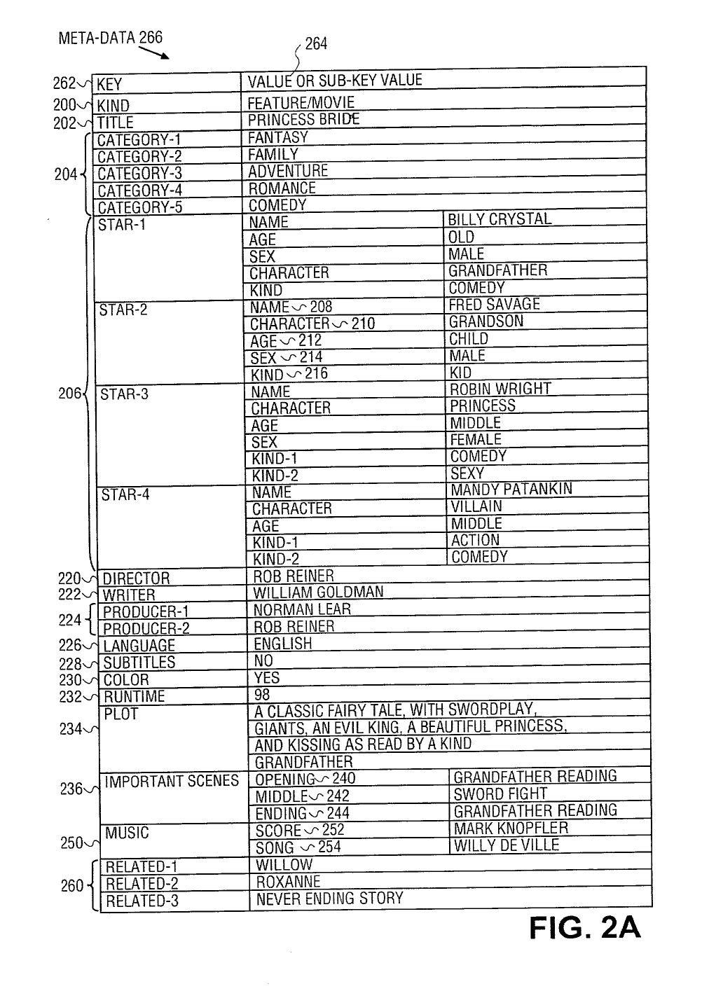

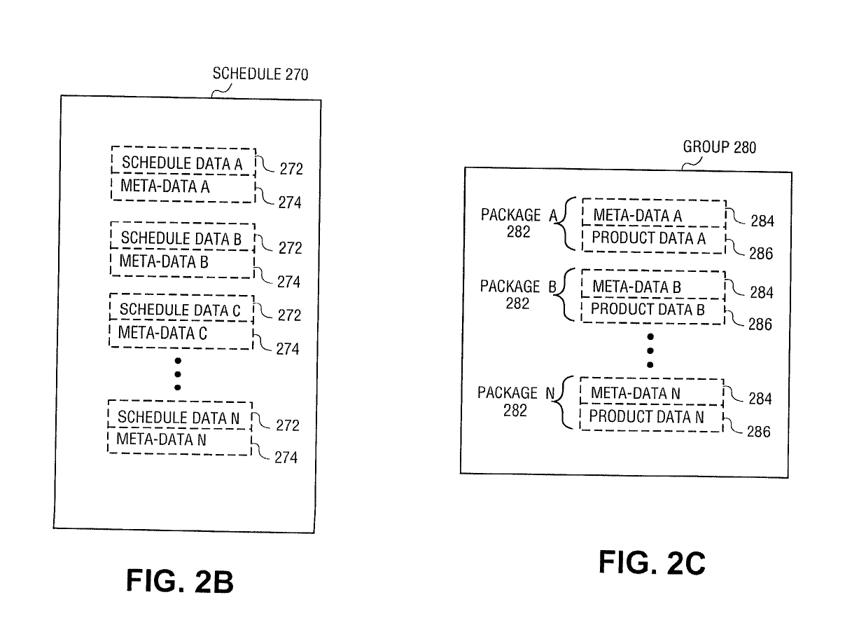

FIG. 2A illustrates product description data according to an embodiment of the invention. In one embodiment, the product description data is meta-data that may have many fields describing the particular product. The fields may be called keys and the descriptions may be referred to as values. In one embodiment, the meta-data may be formatted using the extensible mark-up language (XML). If the product is a movie, feature, preview, short, television program, and the like, meta-data may include, for example, keys 262 and values 264 like those illustrated in FIG. 2A. The keys may include a kind 200, title 202, episode, one or more categories 204, one or more stars 206, one or more directors 220, one or more writers 222, one or more producers 224, language 226, subtitles 228, color 230, runtime 232, one or more plot descriptors 234, one or more key scenes 236, music 250, and one or more related products 260.

Depending on the kind of product, the keys may vary. For example, if the kind is television program, then there may be an episode key which is not used when the kind is movie, video game, audio file or stream, computer program, sporting event, news, etc. In one embodiment, not all keys are mandatory, and the keys are used when appropriate or applicable to the kind of product or the particular instance of the product. Some keys may have sub-keys as needed, and may have further information in sub-sub-keys, etc. For example, in one embodiment, for each star 206, there may be sub-keys for name 208, character played 210, age of the character played 212, sex of the character played 214, and one or more sub-keys for the kind of character played 216. Similarly, important scenes 236 may have sub-keys of opening 240, middle 242, and ending 244. Further, music may have sub-keys for score composer 252 and songs in the product 254. Although only one song 254 is illustrated, multiple songs may be included when appropriate. Additional sub-keys and sub-sub-keys may be used to further describe the kind of music used in the score or song(s) appearing in the product. These keys and sub-keys are only examples, and the number and kind of key, sub-keys, etc. are unlimited. Other keys may include Motion Picture Association of America (MPAA) rating and/or other third party ratings; parental guide classifications such as violence, sex, language, nudity, etc; geographic location; culture; race; religion; etc.

The meta-data stored as the product description data may include values represented in any well-known form and may include text such as title 202, numeric data such as runtime 232, and Booleans such as, for example, color 230. Some keys may allow for a single term or word such as category 204, and others may allow for multiple words such as plot 234. The keys and the representation of values may vary depending on the product and the content provider.

FIG. 2B illustrates a delivery schedule according to one embodiment of the invention. In one embodiment, the delivery center server may communicate a delivery schedule to the clients' set-top boxes informing them of the availability of various products. In another embodiment, the delivery schedule may be an availability list and may specify dates and/or times after which and/or at which products may be available to be acquired or retrieved from a particular download or broadcast channel or stream. In one embodiment, the delivery schedule 270 and availability list may include pairs of schedule data 272 and corresponding meta-data 274 describing the available products. In one embodiment, the schedule data may specify at what day/time the product described by the meta-data will be broadcast. In one embodiment, meta-data 274 is the same as or is similar to the meta-data discussed above regarding FIG. 2A.

FIG. 2C illustrates a group of packages of products according to one embodiment of the invention. In one embodiment, a group 280 of packages 282 which include meta-data 284 and product data 286 may be acquired by and/or delivered to a client. The CPS then determines the products the consumer will likely prefer by keeping track of the meta-data of those products which the consumer views, uses, executes, plays, accesses, etc. In one embodiment, the product data 286 may be the actual movie, television program, preview, raw data, music video, audio file or stream, computer program, video game, etc. In various embodiments, the product data may be protected by a security scheme such as encryption according to any well-known method and standard. In one embodiment, meta-data 284 is the same as or is similar to the meta-data discussed above regarding FIG. 2A.

C. A Method for Evaluating the Relevance of Products

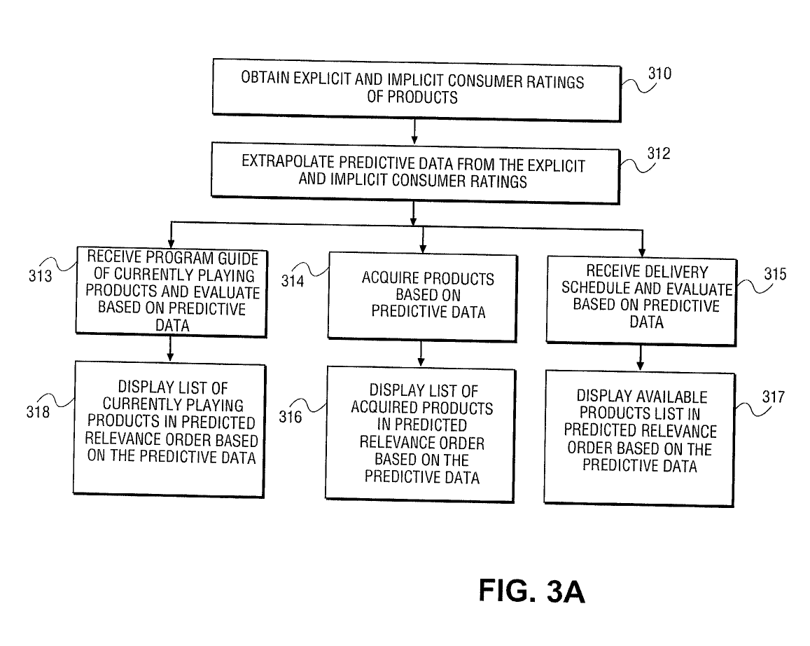

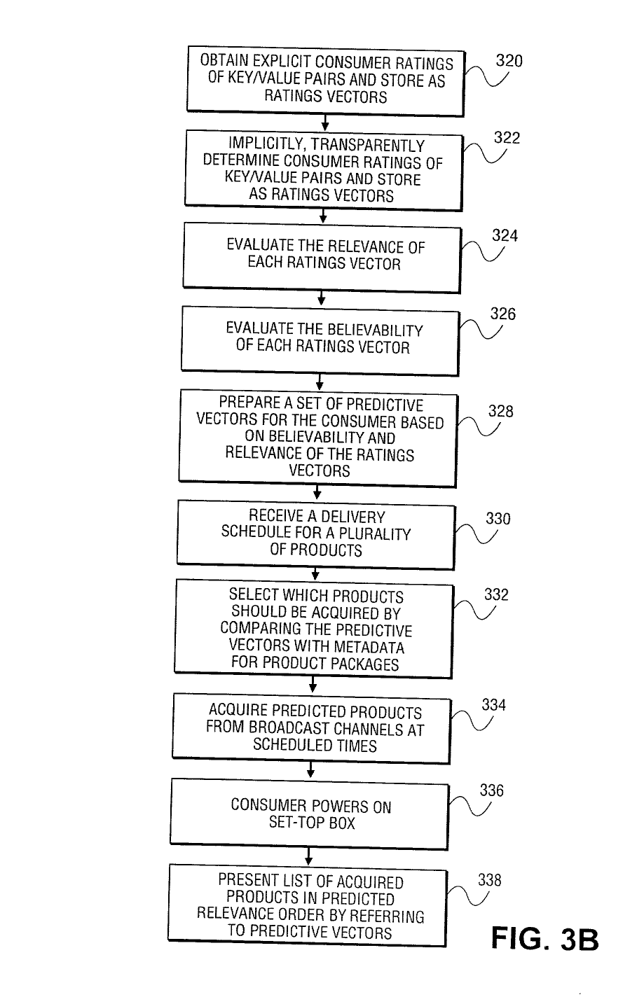

FIG. 3A illustrates a general flow of actions taken pursuant to an embodiment of the invention. As discussed above, a set-top box may include consumer preference software (CPS). In one embodiment, the set-top box may include other software that provides support for a user interface by which the consumer may enter information regarding preferences for the various products which may be broadcast by and/or acquired via the delivery center server. In one embodiment, the user interface software may be combined with the CPS; in another embodiment, the user interface software may be a separate software entity that resides in the set-top box that works in conjunction with the CPS. In one embodiment, the CPS obtains explicit and implicit consumer ratings of products, as shown in block 310. The CPS then extrapolates predictive data from the explicit and implicit consumer ratings, as shown in block 312. The CPS then acquires products based on the predictive data, as shown in block 314. The CPS may then display a list of acquired and stored products accessible via the consumer's set-top box in predicted relevance order to the consumer based on the predictive data, as shown in block 316. In addition, similarly, the CPS may receive a delivery schedule and evaluate the delivery schedule based on the predictive data, as shown in block 315. An available products list based on the delivery schedule may then be displayed to a consumer in predicted relevance order based on the predictive data, as shown in block 317. Further, the CPS may receive a delivery schedule in the form of a program guide of currently available and playing products, and may evaluate the program guide based on the predictive data, as shown in block 313. The CPS may then display a list of currently available and playing products to the consumer in predicted relevance order based on the predictive data, as shown in block 318.

FIG. 3B illustrates a flow of actions taken pursuant to one embodiment of the invention. In one embodiment, to select relevant products to be transparently acquired by the consumer's set-top box and to display a list of acquired and stored products in predicted relevance order, the CPS may obtain explicit consumer ratings of key/value pairs and store the key/value pairs and associated consumer ratings as ratings vectors, as show in block 320. The CPS may also implicitly, transparently determine consumer ratings of key/value pairs and store the key/value pairs and associated consumer ratings as ratings vectors, as shown in block 322. In one embodiment, the rating within a ratings vector may be in the range from, for example, −10 to +10. A key/value pair with a positive rating may indicate that the consumer would prefer a product containing that feature or criteria and should, therefore, be considered for download by the CPS. A negative rating may indicate that a product having the key/value pair would not be enjoyed or appreciated by the consumer and should, therefore, not be requested for download by the CPS. This range and rating scheme is only an example, other similar examples are from −5 to 5, −50 to 50, from −100 to 100, from −1000 to 1000, etc. Moreover, consumer ratings may be defined as any two sided or two dimensional range such as, for example, “A” through “E” and “V” through “Z”, where “A” is most preferred and “E” is least preferred, and “V” is not preferred and “Z” is a never, ever download any product having this key/value pair.

In one embodiment, the CPS may maintain in the PDB detailed information about which products were viewed, acquired, requested, accessed, etc. This allows the CPS to determine a consumer rating for the particular product and/or the particular key/value pairs associated with the product based on whether the product was viewed, accessed, played, executed, etc. once, twice, many times, only for a short period of time less than to conclusion, etc. For example, the PDB may store information that only a small portion such as 25% of a movie was played back, while three other acquired movies were played back in their entireties. Such information may be processed by the CPS to assign a rating to each of the movies. In one embodiment, a consumer rating may be assigned by the CPS to some or all of the key/value pairs associated with a movie based on the percentage of the movie played. Thus, if a movie is only partially played, in one embodiment, the consumer rating for the movie could be a negative value, such as, for example, −3. On the other hand, if a movie is played back in its entirety, the CPS could assign a moderately positive consumer rating of +5. If, for example, a movie is played back two or three times in its entirety, the CPS could assign a relatively high positive rating of +7. In this way, the CPS may conclude based on the number of times and percentage of a whole viewed, accessed, played, executed, etc. of a product whether it was preferred, highly preferred, not preferred, etc. Similar numerical and other ratings could be assigned to key-value pairs based on explicit consumer input and then stored as ratings vectors in the PDB.

In one embodiment, if a recently available product appearing on a list presented to the consumer was not acquired, viewed, accessed, executed, activated, etc. by the consumer, then, according to an embodiment, a negative consumer rating such as not preferred or −5 could be set as a consumer rating for general key/value pairs for the product such as genre, star, director, etc. as well as for other important key/value pairs depending on the type of product. In one embodiment, if a product is presented on a list to a consumer many times and was never viewed, accessed, played, executed, activated, etc. by the consumer, a consumer rating of −9 signifying not preferred may be assigned by the CPS for each of the general and/or most important key/value pairs. Other methodologies for determining a consumer rating associated with some or all of the key/value pairs present in a product are possible. In one embodiment, a rules engine may include multiple rules which are used to evaluate a consumer's habits and assign ratings to key/value pairs. The relevance and believability of the consumer ratings in the ratings vectors are important in evaluating which products should be automatically, transparently acquired. The relevance and believability of the consumer ratings may also be used to determine the order in which the acquired products may be presented to the consumer.

Based on the implicit and explicit consumer rating of key/value pairs, the CPS evaluates the relevance of each of the ratings vectors, as shown in block 324. The CPS then evaluates the believability of each of the ratings vectors, as shown in block 326. How relevance and believability are evaluated is discussed below. The CPS then prepares a set of predictive vectors for the consumer based on the believability and the relevance of each of the ratings vectors, as shown in block 328.

Upon receipt of a delivery schedule or availability list specifying a plurality of products, as shown in block 330, the CPS selects which products should be transparently acquired for the consumer by comparing the predictive vectors for the consumer with meta-data for product packages presented by the delivery center server in the delivery schedule or availability list, as shown in block 332. These selected products may be referred to as predicted products. In one embodiment, the CPS then acquires or retrieves the predicted products from a broadcast or download channel or stream at the scheduled times, as shown in block 334.

After the CPS or the set-top box acquires and stores many products on the storage device in the set-top box, the consumer may power on the set-top box, as shown in block 336. The CPS may provide the consumer various options via a user interface. In one embodiment, either initially upon power on or when otherwise requested by a consumer, the CPS may present a list of acquired products in relevance order by referring to the predictive vectors, as shown in block 338. That is, the CPS evaluates the predicted relevance of the acquired products to the consumer based on the comparison of the meta-data of the acquired products with the predictive vectors. The CPS then lists the stored products in the order of anticipated or predicted relevance to the consumer. In this way, those acquired products that a consumer will most likely want to view, access, play, etc. are presented first, or before others that are not as highly ranked. This presentation in predicted relevance order is particularly helpful to consumers when a large number of products (such as, for example, greater than 20) are stored locally on the set-top box. In addition, when a delivery schedule in the form of a program guide of currently playing products is provided by the delivery center server to the consumer's set-top box, the CPS may evaluate the currently playing products in the same way stored products are evaluated. The CPS may then prepare a list of currently playing products in predicted relevance order and display it to the consumer. Similarly, when a delivery schedule is provided by the delivery center to the set-top box, the CPS may evaluate the available products in the same way stored products are evaluated. In this way, the CPS may prepare a list of available products in predicted relevance order and display it to the consumer.

D. Selecting Predictive Vectors for a Consumer

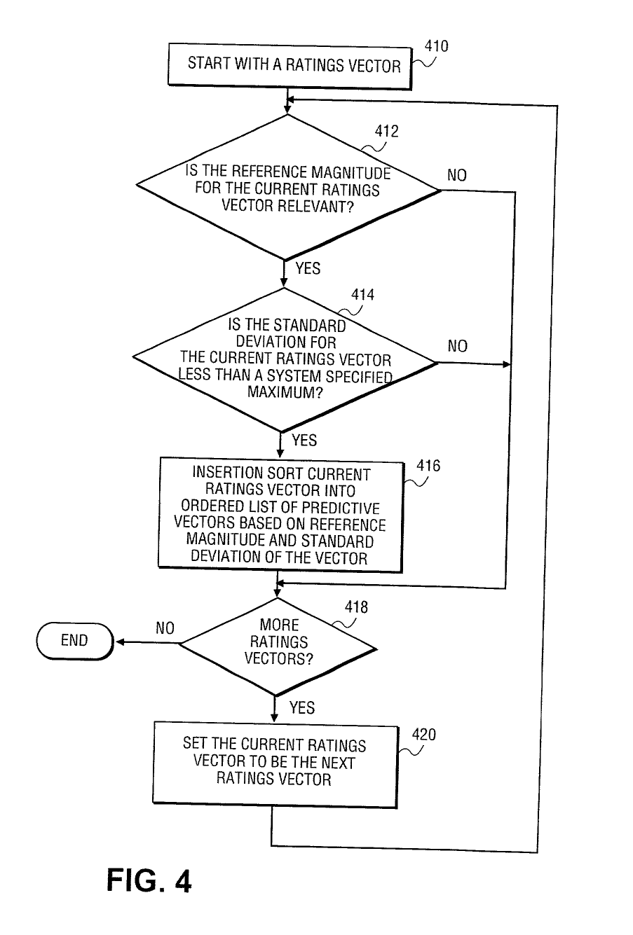

FIG. 4 illustrates a flow of actions taken to prepare a set of predictive vectors for a consumer pursuant to one embodiment of the invention. There are many possible ways of determining and evaluating the predictive vectors and/or predicted relevance of products, although only one such method is described herein. The invention described herein may be implemented using any viable relevance determining method such that the invention is not limited to the predictive vectors and/or predicted relevance method described herein. Generally, the CPS prepares an ordered list of currently playing, available, and/or stored products based on how closely product description data associated with each of the currently playing, available, and/or stored products corresponds to the consumer preferences. In one embodiment, the consumer preferences may be represented as predictive vectors.

In one embodiment, after the CPS has obtained explicit and implicit consumer ratings for various key/value pairs which are stored as ratings vectors, the CPS evaluates each of the ratings vectors to determine which ratings vectors should be used to predict which products should be transparently acquired from the delivery center server. The CPS starts with a ratings vector, as shown in block 410. The ratings vectors may be retrieved from a preference database (PDB) stored on a storage device within the set-top box.

In one embodiment, for each ratings vector, the CPS may maintain a preference magnitude, a reference magnitude and a standard deviation, or the CPS may, as needed, determine the preference magnitude, the reference magnitude and the standard deviation for each of the ratings vectors. The preference magnitude or P_{MAG} may also be referred to as a consumer preference level and is the average of consumer ratings for the particular key/value pair of the ratings vector, where each consumer rating may have been implicitly evaluated by the CPS and/or may have been explicitly provided by the consumer.

The reference magnitude or R_{MAG} of a ratings vector is the raw number of times a key/value pair was present within a product for which a consumer rating was determined by the CPS. The greater the reference magnitude the more relevant the associated consumer preference level will be in forecasting products that should be downloaded. That is, the more times a consumer rating was determined or retrieved for a key/value pair, the more likely the chance that the resulting consumer preference level should be considered in evaluating whether a particular product should be downloaded.

The standard deviation or StdDev of the preference magnitude is the standard deviation of the collected consumer ratings for the key/value pair of the particular ratings vector. The standard deviation is used to determine the believability of the preference magnitude of the consumer ratings for the key/value pairs. That is, the smaller the standard deviation for the particular key/value pair, the more believable or reliable the key/value pair's consumer preference level will be in determining whether a consumer will prefer a particular product. It follows that, the greater the standard deviation of a key/value pair, the less believable or less reliable the key/value pair's consumer preference level will be in determining whether a consumer will prefer a particular product.

Using the reference magnitude for the ratings vector, the CPS determines whether the reference magnitude for the current ratings vector is relevant, as shown in block 412. In one embodiment, the CPS determines the reference magnitude as a raw count of the number of occurrences of the particular key/value pair. To determine whether the reference magnitude is relevant, in one embodiment, the CPS may compare the reference magnitude to the total number of products downloaded by the consumer. In another embodiment, the reference magnitude may be considered significant based on a raw comparison with the other reference magnitudes of all other stored key/value pairs. If the reference magnitude for the current key/value pair is significant, the standard deviation for the current ratings vector is evaluated to determine whether it is less than a system specified maximum, as shown in block 414. The standard deviation is the accumulated standard deviation of all consumer ratings assigned to the particular key/value pair. In one embodiment, a system specified maximum for a standard deviation may be set. In one embodiment, the system specified maximum standard deviation may vary based on the kind of ratings vector that is being evaluated.

If the standard deviation for the current ratings vector is less than the system specified maximum, as shown in block 414, the CPS inserts the current ratings vector into an ordered list of predictive vectors based, in one embodiment, on the reference magnitude and the standard deviation of the current ratings vector, as shown in block 416. The reference magnitude and standard deviation may be combined in any appropriate way. In one embodiment, this may be achieved by a well-known insertion sort method. In one embodiment, the ordered list of predictive vectors is stored in the preferences database on the consumer's set-top box. A check is then made to determine whether there are more ratings vectors to evaluate, as shown in bock 418. If there are more ratings vectors to evaluate, the current ratings vector is set to be the next ratings vector, as shown in block 420. Execution then continues at block 412.

If, when evaluating a ratings vector, it is determined that the reference magnitude for the current ratings vector is not significant, as shown in block 412, the ratings vector is not added to the ordered list of predictive vectors, and execution continues at block 418 with the processing of any additional ratings vectors. Similarly, if the standard deviation for the current ratings vector is not less than a system specified maximum, as shown in block 414, execution continues at block 418 with the evaluation of additional ratings vectors, if any. When the standard deviation is not less than the system specified maximum, the ratings vector is not added to the predictive vector list. If in block 418 there are no further ratings vectors to evaluate, the processing to determine predictive vectors ends.

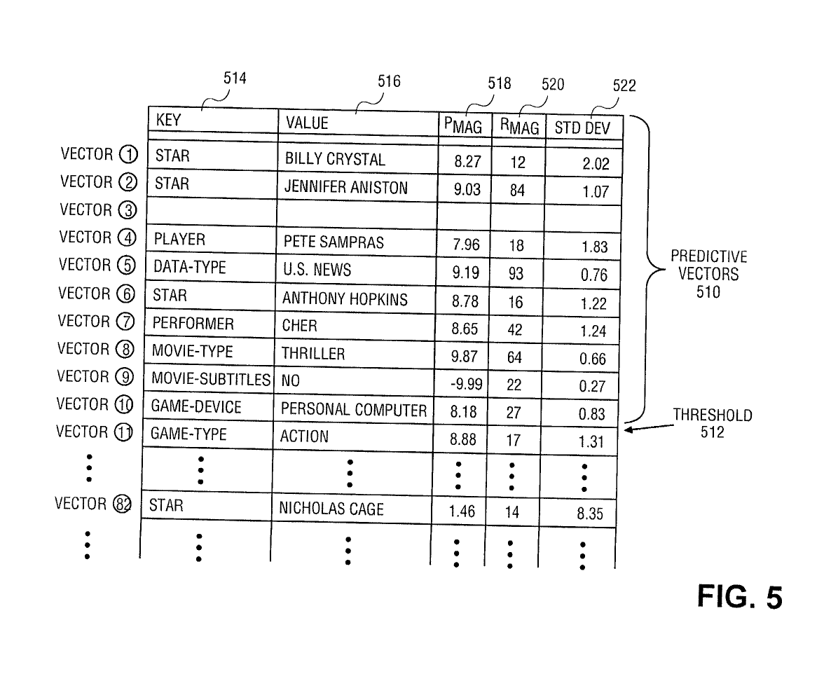

FIG. 5 illustrates a set of predictive vectors according to one embodiment of the invention. In one embodiment, a set of predictive vectors 510 may include the best vectors from, or the top vectors from the analysis performed in the description of FIG. 4. In one embodiment, a threshold 512 may be used by the CPS to determine a cut-off point between the best predictive vectors and other vectors. In one embodiment, the threshold may be a raw number such as the number 10 so that those vectors that are predictive vectors are the top 10 vectors found when analyzing pursuant to the method described regarding FIG. 4. In another embodiment, the threshold may be a numerical value such that a combination of the reference magnitude and the standard deviation may be used to determine the top group of vectors which should become predictive vectors. In one embodiment, each of the predictive vectors may be stored with five elements: Key 514, value 516, P_{MAG} 518, R_{MAG} 520, and StdDev 522.

To better understand how the predictive vectors are chosen and how the ratings vectors are aligned, reference is made to vector 82 of FIG. 5, in which the key is “star”, the value is “Nicholas Cage”, the P_{MAG} is “1.46”, the R_{MAG} is “14”, and the standard deviation is “8.35”. Such a set of elements in a ratings vector may derive from the fact that a consumer may have enjoyed and watched various movies staring Nicholas Cage, such as, for example, Honeymoon in Vegas, Moonstruck, and Raising Arizona, while the consumer may have explicitly chosen not to watch or not to acquire Face-Off, Con Air, and The Rock. As such, because the consumer liked some of Mr. Cage's movies and choose not to view others, the standard deviation of the consumer's ratings is large. Therefore, the believability of this ratings vector is considered relatively low or not believable. Because the believability is low, the particular ratings vector does not meet the threshold to be included as one of the predictive vectors. As another example, refer to vector 2, in which the key is “star”, the value is “Jennifer Aniston”, the P_{MAG} is “9.03”, the R_{MAG} is “84”, and the standard deviation is “1.47”. In this example, the consumer has apparently watched numerous episodes of the television series Friends in which Ms. Aniston stars such that the R_{MAG} is a relatively high 84. That is, there are 84 instances in which the CPS determined a consumer rating for Ms. Aniston. It follows that, because the consumer enjoyed watching Ms. Aniston on numerous occasions, the standard deviation is relatively low at 1.07. What this means is that the consumer viewed a product staring Ms. Aniston 84 times, and, because the standard deviation is 1.07 and the P_{MAG} is 9.03, the CPS may have determined that the consumer rating for Ms. Aniston was approximately between 8 and 10 on numerous of the 84 occasions in which a consumer rating was generated regarding the key/value pair “star/Jennifer Aniston”. In addition, the consumer may have explicitly provided a rating of, for example, 9 out of 10 to Ms. Aniston.

E. Product Selection and Listing Based on Predicted Consumer Preferences

To determine which products to acquire for a consumer, generally, the CPS evaluates each key/value pair of the meta-data within a group of packages, delivery schedule or availability list to determine whether the key/value pairs of the predictive vectors are included in the meta-data. For each of the packages or products listed in the schedule having at least one key/value pair that matches a predictive vector, a comparison is made between all key/value pairs of the package and all predictive vectors. A predictive preference level for the package is then determined based on the total number of matching predictive vectors, the total standard deviation, and the total reference magnitude of the package. Those products having the greatest predictive preference level are then transparently acquired. The meta-data and product data for each product are stored on the storage device in the set-top box as packages. The acquired products may be presented to the consumer in an ordered list based on the predicted preference level for the stored products. In this same way, a list of currently playing products and/or a list of available products may be presented to the consumer in an order based on the predicted preference level for each of the products currently playing and/or available.

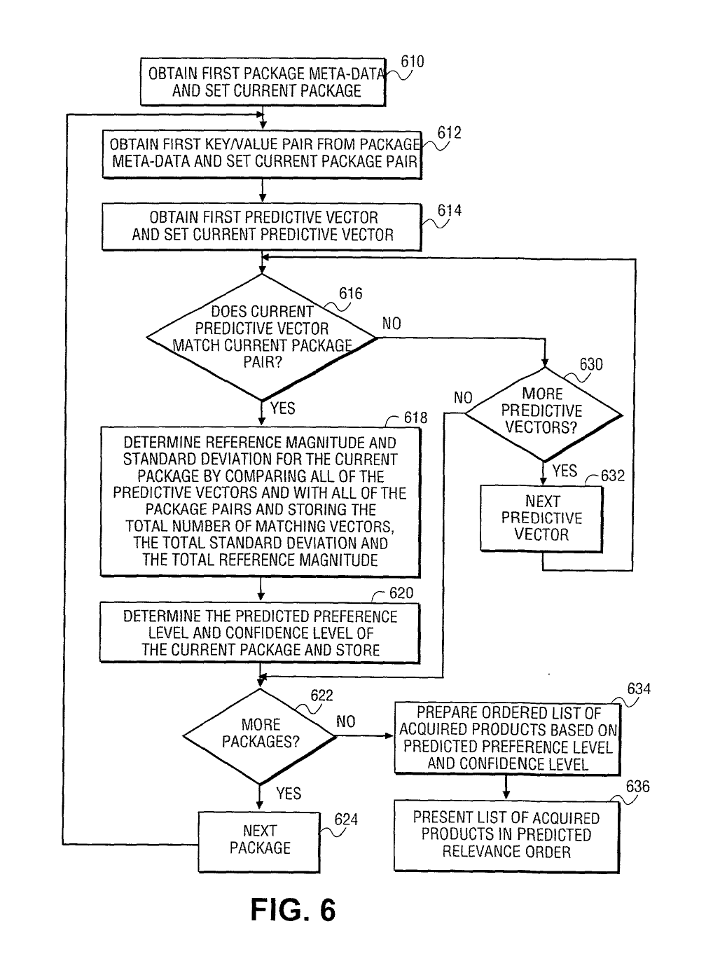

FIG. 6 illustrates a flow of actions taken to prepare an ordered listing of stored products according to one embodiment of the invention. In one embodiment, after many acquired packages are stored in the set-top box, the CPS presents a list of stored products to the consumer in predicted relevance order. The CPS reads the metadata for a first package and sets it as the current package, as shown in block 610. The CPS then obtains the first key/value pair from the package meta-data and sets the current package pair, as shown in block 612. The CPS then obtains the first predictive vector from the list of predictive vectors and sets the current predictive vector, as shown in block 614. The CPS then determines whether the current predictive vector matches the current package pair, as shown in block 616. If the current predictive vector matches the current package pair, the CPS determines the reference magnitude and the standard deviation for the current package by comparing all of the predictive vectors with all of the package pairs, and storing the total number of matching predictive vectors, the total standard deviation for all matching predictive vectors, and the total reference magnitude, as shown in block 618. The CPS then determines the predicted preference level and the competence level of the current package and stores these values, as shown in block 620. In one embodiment, the predicted preference level is determined by dividing the total reference magnitude by the total number of matching predictive vectors, such that the predicted preference level is the average reference magnitude of all matching predictive vectors. In one embodiment, the competence level is determined by dividing the total standard deviation of all matching predictive vectors by the total number of matching predictive vectors, such that the competence level is the average standard deviation of all matching predictive vectors.

A check is then made to determine whether there are any further packages to evaluate, as shown in block 622. If there are more packages, the current package is set to be the next package, as shown in block 624, and execution continues at block 612. If there are no further packages, as shown in block 622, an ordered list of acquired products is prepared based on the predicted preference levels and confidence levels of the products, as shown in block 634.

Referring again to block 616, if the current predictive vector does not match the current package pair, a check is made to determine whether there are any further predictive vectors to evaluate, as shown in block 630. If there are additional predictive vectors, the current predictive vector is set to be the next predictive vector, as shown in block 632. Execution then continues at block 616. If there are no additional predictive vectors to evaluate, as shown in block 630, execution continues at block 622.

In one embodiment, upon receipt of a delivery schedule from a delivery center server the CPS may process and evaluate the delivery schedule according to the methods described above regarding the selection of products to be acquired and listing of acquired products. That is, in this embodiment, the CPS may present an ordered listing of products that are or will be available to be acquired. This ordered listing of available products may be created by evaluation the delivery schedule according to the methods described above. In this way, a consumer may be presented with an ordered listing of available products which are most likely to be preferred by the consumer. By presenting the ordered list of available products in addition to and/or in place of a traditional date/time/channel listing, the CPS enhances the consumer's ability to readily, easily, and efficiently locate those programs and products the consumer will most likely prefer to view, watch, access, play, etc.

In one embodiment, upon receipt from the delivery center of a program guide of currently playing programs and other products, the CPS may evaluate the program guide according to the method described above regarding the selection of products to be acquired and the listing of acquired products. That is, in this embodiment, the CPS may present an ordered listing of currently playing products based on an evaluation of the program guide according to the methods described above. In this way, a consumer may be presented with an ordered listing of currently playing programs which are most likely to be preferred by the consumer. By presenting the ordered list of currently playing programs in addition to and/or in place of a traditional date/time/channel listing, the CPS enhances the consumer's ability to readily, easily, and efficiently locate those programs and products the consumer will most likely prefer to view, watch, access, play, etc.

In another embodiment, the CPS may reside on the delivery center server. In this embodiment, the CPS may determine consumer preferences both implicitly and/or explicitly based on information fed to the delivery center server from the client's set-top box. In this way, CPS on the delivery center server may execute the various embodiments of the invention described herein in the same way as if the CPS were located on the consumer's set-top box. In another embodiment, CPS on the delivery center server may also use additional data to determine consumer's preferences, such as, for example, the consumer's billing records which, in one embodiment, may be maintained in a database at the delivery center server. In yet another embodiment, CPS on the delivery center server may communicate with additional third party databases to obtain further consumer information linked to the street address and/or telephone number associated with the registration information or billing information associated with the consumer's set-top box. The delivery center server CPS may use this further data in determining the consumer's preferences. In all of these embodiments, after determining additional consumer preferences, products tailored to the consumer's predicted tastes are broadcast so that they may be transparently acquired by the consumer's set-top box.

In another embodiment, a delivery preference software (DPS) program may be stored on the storage device of the delivery center server. In this embodiment, the DPS may execute in conjunction with CPS running on a client or on the delivery center server. In this embodiment, the DPS may customize a broadcast schedule for a particular consumer based on the predictive vectors for the consumer that are determined by the CPS. In this way, the delivery center may prepare a broadcast schedule for a consumer that is more likely to meet the consumer's preferences. In various embodiments, predictive vectors may be aggregated and used for particular geographic regions, particular demographic groups based on various factors including viewing habits, billing information, third party data, etc. In these embodiments, the DPS may include the functionality of the CPS or may be paired with the CPS.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
obtaining a plurality of consumer preferences;
receiving a delivery schedule from a server listing a plurality of available products available from the server;
creating an ordered list of available products by evaluating the plurality of available products based on the consumer preferences; and
presenting the ordered list of available products to the consumer.

2. The method of claim 1 wherein the consumer preferences include a plurality of implicit preferences and a plurality of explicit preferences.

3. The method of claim 1 wherein the plurality of products listed in the delivery schedule comprise at least one of movies, computer games, music videos, audio files, raw data, computer programs, previews, television programs and news programs.

4. The method of claim 1 further comprising:
receiving a consumer selection of one of the available products from the ordered list; and
storing one of the available products responsive to receiving the consumer selection.

5. The method of claim 1 wherein the delivery schedule includes a set of product description data for each of the products in the delivery schedule.

6. The method of claim 5 wherein creating comprises:
determining a plurality of ratings vectors based on the consumer preferences;
deriving a plurality of predictive vectors based on the ratings vectors; and
ordering the products in the delivery schedule based on how closely the product description data of each of the products corresponds to the predictive vectors.

7. The method of claim 6 wherein deriving the plurality of predictive vectors comprises:
evaluating a reference magnitude, a preference magnitude and a standard deviation for each of a plurality of key/value pairs included in the ratings vectors.

8. The method of claim 7 wherein deriving the plurality of predictive vectors further comprises:
sorting each of the ratings vectors based on a relevance of each of the ratings vectors.

9. The method of claim 8 wherein:
the relevance of each of the ratings vectors is based on the reference magnitude of the ratings vectors.

10. The method of claim 9 wherein:
the sorting is further based on a believability of each of the ratings vectors; and
the believability of each of the ratings vectors is based on the standard deviation for each of the ratings vectors.

11. The method of claim 6 wherein the ordering is based on a competence level and a predicted preference level of each of the products in the delivery schedule derived by comparing the product description data of each product with each of the predictive vectors.

12. The method of claim 11 wherein:
the predicted preference level is based on a reference magnitude of all matching predictive vectors; and
the competence level is based on a standard deviation of all matching predictive vectors.

13. A method comprising:
obtaining a plurality of consumer preferences;
storing a plurality of products obtained from a server based on the consumer preferences as a plurality of stored products;
creating an ordered list of stored products by evaluating the stored products based on the consumer preferences; and
presenting the ordered list of stored products to the consumer.

14. The method of claim 13 wherein the consumer preferences include a plurality of implicit preferences.

15. The method of claim 14 wherein the consumer preferences further include a plurality of explicit preferences.

16. The method of claim 13 wherein the plurality of stored products comprise at least one of movies, computer games, music videos, audio files, raw data, computer programs, previews, television programs and news programs.

17. The method of claim 13 further comprising:
receiving a consumer selection of one of the stored products from the ordered list; and
presenting one of the stored products to the consumer responsive to receiving the consumer selection.

18. The method of claim 13 wherein each of the plurality of stored products includes product data and a corresponding set of product description data.

19. The method of claim 18 wherein creating comprises:
ordering the ordered list of stored products based on how closely the product description data of each of the stored products corresponds to the consumer preferences.

20. A method comprising:
obtaining a plurality of consumer preferences;
receiving a delivery schedule from a server listing a plurality of currently playing products;
creating an ordered list of currently playing products by evaluating the currently playing products based on the consumer preferences; and
presenting the ordered list of currently playing products to the consumer.

21. The method of claim 20 wherein the consumer preferences include a plurality of implicit preferences.

22. The method of claim 21 wherein the consumer preferences further include a plurality of explicit preferences.

23. The method of claim 20 further comprising:
receiving a consumer selection of one of the currently playing products from the ordered list; and
presenting one of the currently playing products to the consumer responsive to receiving the consumer selection.

24. The method of claim 20 wherein the delivery schedule is a program guide that includes a set of product description data for each of the currently playing products in the delivery schedule.

25. The method of claim 24 wherein creating comprises:
ordering the ordered list of currently playing products based on how closely the product description data of each of the currently playing products corresponds to the consumer preferences.

26. A system comprising:
a user input device to receive user input;
a television monitor;
a set-top box including a processor, a memory, a storage device, a communications interface, an output controller, and a user input controller each coupled to a bus, the set-top box coupled to the television monitor via the output controller, the user input device coupled to the set-top box via the user input controller, and the set-top box coupled to a delivery center server via the communications interface; and
a software program included on the storage device which when executed enables the set-top box to perform operations comprising:
obtaining a plurality of consumer preferences;
receiving a delivery schedule from a server listing a plurality of available products available from the server;
creating an ordered list of available products by evaluating the plurality of available products based on the consumer preferences; and
presenting the ordered list of available products to the consumer via the television monitor.

27. The system of claim 26 wherein the consumer preferences include a plurality of implicit preferences and a plurality of explicit preferences.

28. The system of claim 26 wherein the software program enables the set-top box to perform further operations comprising:
receiving a consumer selection of one of the available products from the ordered list via the user input device; and
storing one of the available products on the storage device responsive to receiving the consumer selection.

29. The system of claim 26 wherein creating comprises:
ordering the ordered list of available products based on how closely product description data associated with each of the available products corresponds to the consumer preferences.

30. A system comprising:
a user input device to receive user input;
a television monitor;
a set-top box including a processor, a memory, a storage device, a communications interface, an output controller, and a user input controller each coupled to a bus, the set-top box coupled to the television monitor via the output controller, the user input device coupled to the set-top box via the user input controller, and the set-top box coupled to a delivery center server via the communications interface; and
a software program included on the storage device which when executed enables the set-top box to perform operations comprising:
obtaining a plurality of consumer preferences;
storing a plurality of products obtained from a server based on the consumer preferences as a plurality of stored products;
creating an ordered list of stored products by evaluating the stored products based on the consumer preferences; and
presenting the ordered list of stored products to the consumer via the television monitor.

31. The system of claim 30 wherein the consumer preferences include a plurality of implicit preferences and a plurality of explicit preferences.

32. The system of claim 30 wherein the software program enables the set-top box to perform further operations comprising:
receiving a consumer selection of one of the stored products from the ordered list via the user input device; and
presenting one of the stored products to the consumer via the television monitor responsive to receiving the consumer selection.

33. The system of claim 30 wherein creating comprises:
ordering the ordered list of stored products based on how closely product description data associated with each of the stored products corresponds to the consumer preferences.

34. A system comprising:
a user input device to receive user input;
a television monitor;
a set-top box including a processor, a memory, a storage device, a communications interface, an output controller, and a user input controller coupled to a bus, the set-top box coupled to the television monitor via the output controller, the user input device coupled to the set-top box via the user input controller, and the set-top box coupled to a delivery center server via the communications interface; and
a software program included on the storage device which when executed enables the set-top box to perform operations comprising:
obtaining a plurality of consumer preferences;
receiving a program guide from a server listing a plurality of currently playing products;
creating an ordered list of currently playing products by evaluating the currently playing products based on the consumer preferences; and
presenting the ordered list of currently playing products to the consumer via the television monitor.

35. The system of claim 34 wherein the consumer preferences include a plurality of implicit preferences and a plurality of explicit preferences.

36. The system of claim 34 wherein the software program enables the set-top box to perform further operations comprising:
receiving a consumer selection of one of the currently playing products from the ordered list via the user input device; and
presenting one of the currently playing products to the consumer via the television monitor responsive to receiving the consumer selection.

37. The system of claim 34 wherein creating comprises:
ordering the ordered list of currently playing products based on how closely product description data associated with each of the currently playing products corresponds to the consumer preferences.

38. A machine readable medium including instructions stored thereon which when executed by a processor cause the processor to perform operations comprising:
obtaining a plurality of consumer preferences;
receiving a delivery schedule from a server listing a plurality of available products available from the server;
creating an ordered list of available products by evaluating the plurality of available products based on the consumer preferences; and
presenting the ordered list of available products to the consumer.

39. The machine readable medium of claim 38 wherein the consumer preferences include a plurality of implicit preferences and a plurality of explicit preferences.

40. The machine readable medium of claim 38 having further instructions stored thereon which cause the processor to perform further operations comprising:
receiving a consumer selection of one of the available products from the ordered list; and
storing one of the available products responsive to receiving the consumer selection.

41. The machine readable medium of claim 38 wherein creating comprises:
ordering the ordered list of available products based on how closely product description data associated with each of the available products corresponds to the consumer preferences.

42. A machine readable medium including instructions stored thereon which when executed by a processor cause the processor to perform operations comprising:
obtaining a plurality of consumer preferences;
storing a plurality of products obtained from a server based on the consumer preferences as a plurality of stored products;
creating an ordered list of stored products by evaluating the stored products based on the consumer preferences; and
presenting the ordered list of stored products to the consumer.

43. The machine readable medium of claim 42 wherein the consumer preferences include a plurality of implicit preferences and a plurality of explicit preferences.

44. The machine readable medium of claim 42 having further instructions stored thereon which cause the processor to perform further operations comprising:
receiving a consumer selection of one of the stored products from the ordered list; and
presenting one of the stored products responsive to receiving the consumer selection.

45. The machine readable medium of claim 42 wherein creating comprises:
ordering the ordered list of stored products based on how closely product description data associated with each of the stored products corresponds to the consumer preferences.

46. A machine readable medium including instructions stored thereon which when executed by a processor cause the processor to perform operations comprising:
obtaining a plurality of consumer preferences;
receiving a delivery schedule from a server listing a plurality of currently playing products;
creating an ordered list of currently playing products by evaluating the currently playing products based on the consumer preferences; and
presenting the ordered list of currently playing products to the consumer.

47. The machine readable medium of claim 46 wherein the consumer preferences include a plurality of implicit preferences and a plurality of explicit preferences.

48. The machine readable medium of claim 46 having further instructions stored thereon which cause the processor to perform further operations comprising:
receiving a consumer selection of one of the currently playing products from the ordered list; and
presenting one of the currently playing products responsive to receiving the consumer selection.

49. The machine readable medium of claim 46 wherein creating comprises:
ordering the ordered list of currently playing products based on how closely product description data associated with each of the currently playing products corresponds to the consumer preferences.
